(19) United States
(12) Patent Application Publication
(10) Pub. No.: US 2026/0142832 A1
(43) Pub. Date: May 21, 2026

(54) SYSTEMS AND METHODS FOR ENHANCED ACCOUNT SECURITY VIA DUAL PASSKEY AUTHENTICATION

(71) Applicant: Wells Fargo Bank, N.A., San Francisco, CA (US)

(72) Inventors: John Andrew Chuprevich, Charlotte, NC (US); Matthew N. Wheeler, Charlotte, NC (US); Kimberly R. Nelson, Charlotte, NC (US)

(21) Appl. No.: 18/955,443

(22) Filed: Nov. 21, 2024

(51) Int. Cl. H04L 9/32

(52) U.S. Cl. CPC H04L 9/3247; H04L 9/3226; H04L 9/3271

(57) ABSTRACT

Systems, apparatuses, methods, and computer program products are disclosed for enhanced authentication using a dual passkey authentication routine. An example method includes receiving a user operation request from a primary user device associated with a primary user and determining a dual passkey authentication requirement for the operation request type based on the primary user account. The example method further includes selecting a guardian user device and performing a dual passkey authentication routine to determine whether to authenticate the user operation request. The example method further includes performing an operational routine associated with the operation request type for the primary user account in response to successfully authenticating the user operation request.

### BACKGROUND

User account security is paramount for keeping sensitive user information safe and out of the hands of bad actors. Passkeys are designed to improve security and usability by providing passwordless authentication that leverages cryptographic keys to ensure only a legitimate user can access his/her user account.

### BRIEF SUMMARY

The use of passkeys for authentication is an improvement over the traditional password-based system. The traditional password method for user authentication typically relies on an alphanumeric string (e.g., a password) to grant access to a service and/or an account. The password used in this process may be stolen, guessed, and/or cracked by cryptanalysis with relative ease. In contrast, the passkey system may leverage more secure cryptographic keys for user authentication. In particular, a user device locally stores a private cryptographic key and this key may be further secured through the various security systems on the user device (e.g., fingerprint recognition, face recognition, retinal scanning, and/or other biometric and security processes). A corresponding public cryptographic key is stored by the account service provider. The user may utilize the user device, registered to the passkey system, to request access to a service and/or an account. To allow access to a service and/or an account using a passkey, a digital challenge may be sent from the service provider to the user device. The private cryptographic key, accessed through the onboard security measures of the user device, may be used to sign the digital challenge, which is then sent back to the service provider for authentication. In an instance where the signature on the signed digital challenge corresponds to the stored public key, stored by the service provider, the user device is granted access to the desired service and/or account.

While the passkey system mitigates risks associated with password theft, database breaches, and phishing, existing passkey systems typically rely on a single user device to store the private cryptographic key. Thus, this can be a single point of failure if the user device is ever compromised. Furthermore, current systems typically rely on a single user for authentication and have limited to no options available for involving additional users and/or user devices. This may be particularly problematic for vulnerable user populations, who may not be equipped to recognize potential frauds and/or scams.

In contrast to these conventional techniques for passkey authentication, example embodiments herein describe a method for providing enhanced user account security by implementing a dual passkey authentication routine. In particular, a primary user may configure his/her primary user account with a dual passkey authentication requirement. This dual passkey authentication requirement may cause a dual passkey authentication routine to be used for some user operation requests corresponding to certain operation request types. In some examples, the primary user may select the particular operation request types and/or conditions for which the dual passkey authentication routine is to be used, thus providing flexibility and control over the primary user account to the primary user. The primary user may also associate one or more guardian user devices with the primary user account. These associated guardian user devices may be used during the dual passkey authentication routine to authenticate a user operation request.

In particular, upon receipt of a user operation request from the primary user device, example embodiments may determine whether the primary user account is associated with a dual passkey authentication requirement and, if so, whether the user operation request requires a dual passkey authentication routine. If the user operation request requires a dual passkey authentication routine, a guardian user device associated with the primary user account may be selected and the dual passkey authentication routine may be performed. During the dual passkey authentication routine, a first challenge is sent to a primary user device and a second challenge is sent to the selected guardian user device. The primary user device may digitally sign the first challenge to produce a first digital signature, and the guardian user device may digitally sign the second challenge to produce a second digital signature. Both the first digital signature and second digital signature may be authenticated, and if both digital signatures are successfully authenticated, the user operation request may be successfully authenticated. By requiring two independent passkeys, the risk of unauthorized access to the primary user account is significantly decreased, even if one user device is compromised. This is because the private cryptographic keys of the corresponding passkey are stored on either the primary user device or the guardian user device. Thus, even if the primary user device is compromised and the first digital signature is successful, the guardian user device may not provide the second digital signature, and the user operation may not be authenticated.

In some embodiments, the passkey of the guardian user device is specific and uniquely associated with the primary user account. Even if the guardian user device is owned by a guardian user who is different than the primary user, the passkey of the guardian user device is linked only to the primary user account. For example, if the guardian user device is owned by a guardian user different than the primary user, the guardian user device may store a private cryptographic key associated with a corresponding guardian user account as well as a private cryptographic key associated with the primary user account without the passkeys conflicting. This also ensures that the security around the guardian user account is maintained but still allows the guardian user device to be used during the dual passkey authentication routine. Additionally, the particular passkey associated with the guardian user device may be associated with restricted permissions such that the guardian user may only use the passkey during the dual passkey authentication routine but cannot use the passkey to access the primary user account.

Additionally, the primary user may associate multiple guardian user devices with his/her primary user account. When the primary user associates a guardian user device with his/her primary user account, example embodiments may provide a configuration request to the indicated guardian user device. In some embodiments, the configuration request may be provided indirectly by providing the configuration request to the primary user device, which in turn must provide the configuration request to the guardian user device. This may ensure that the primary user device and guardian user device are within proximity of one another and avoid associated unintended user devices with the primary user account. The configuration request may instruct the guardian user device to generate a passkey comprising the private cryptographic key and public cryptographic key, store the private cryptographic key, and provide the public cryptographic key. In some embodiments, the configuration request may further allow the guardian user device to provide an availability schedule indicative of when the guardian user device is available for participation in the dual passkey authentication routine. Thus, a guardian user may provide an indication of his/her availability, and the guardian user device may not be selected when the guardian user is unavailable. This avoids delays, timeouts, or other complications associated with selecting an unavailable guardian user device for a dual passkey authentication routine.

Accordingly, the present disclosure sets forth systems, methods, and apparatuses that achieve an enhanced passkey for user account security. There are many advantages of these and other embodiments described herein. For instance, the additional security requirements for dual passkey authentication may increase the trustworthiness or confidence in a primary user identity and/or in the legitimacy of a user operation request. Thus, authentication using a dual passkey authentication routine may enable the entity to authenticate user operation requests that would otherwise require additional authentication measures, such as multifactor authentication. Additionally, authentication using a dual passkey authentication routine may further enable the entity to authenticate user operation requests that are traditionally not allowed to be authenticated digitally. For example, if the entity is a financial service provider and a dual passkey authentication routine is used, the entity may be able to authenticate user operation requests that are considered high risk or currently require an in-person visit to a financial institution branch. By way of particular example, a dual passkey authentication routine may enable authentication of user operation requests pertaining to transferring funds above a normal limit, linking the user account to external user accounts, applying for loans, opening a new account, changing user account information, resetting user account passwords, and/or the like.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2 illustrates a schematic block diagram of example circuitry embodying a system device that may perform various operations, in accordance with some example embodiments described herein.

FIG. 3 illustrates an example flowchart for configuring a primary user account with a dual passkey authentication requirement, in accordance with some example embodiments described herein.

FIG. 4 illustrates an example flowchart for authenticating a user operation request using a dual passkey authentication routine, in accordance with some example embodiments described herein.

FIG. 5 illustrates an example flowchart for determining whether a proximity threshold is satisfied, in accordance with some example embodiments described herein.

FIG. 6 illustrates an example flowchart for performing a dual passkey authentication routine, in accordance with some example embodiments described herein.

FIG. 7 illustrates an example flowchart for the authenticating a first digital signature provided by a primary user device during the dual passkey authentication routine, in accordance with some example embodiments described herein.

FIG. 8 illustrates an example flowchart for the authenticating a second digital signature provided by a guardian user device during the dual passkey authentication routine, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers, programmable automation controllers, industrial computers, desktop computers, personal data assistants, laptop computers, tablet computers, smartbooks, palm-top computers, personal computers, smartphones, wearable devices (such as headsets, smartwatches, or the like), and similar electronic devices equipped with at least a processor and any other physical components necessary to perform the various operations described herein. Devices such as smartphones, laptop computers, tablet computers, and wearable devices are generally collectively referred to as “mobile devices.”

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

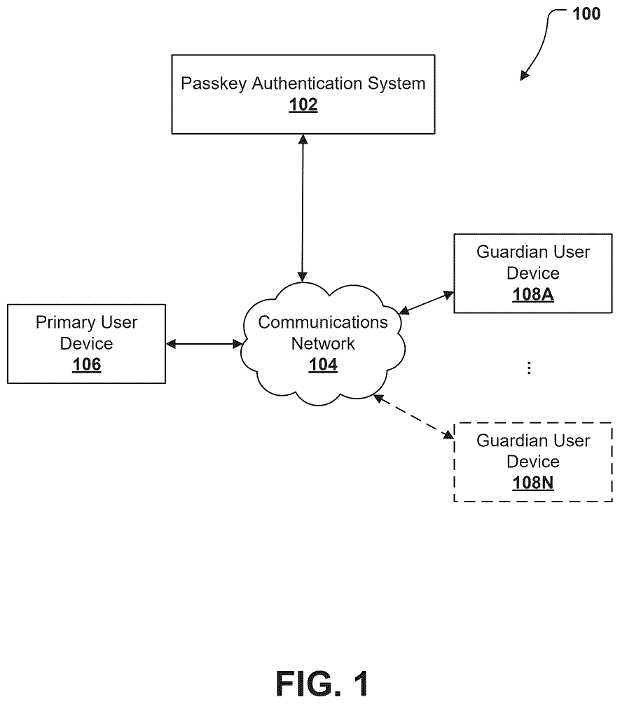

Example embodiments described herein may be implemented using any of a variety of computing devices or servers. To this end, FIG. 1 illustrates an example environment 100 within which various embodiments may operate. As illustrated, a passkey authentication system 102 may receive and/or transmit information via communications network 104 (e.g., the Internet) with any number of other computing devices, such as a primary user device (e.g., primary user device 106) and/or guardian user devices (e.g., any one of the guardian user devices 108A-108N).

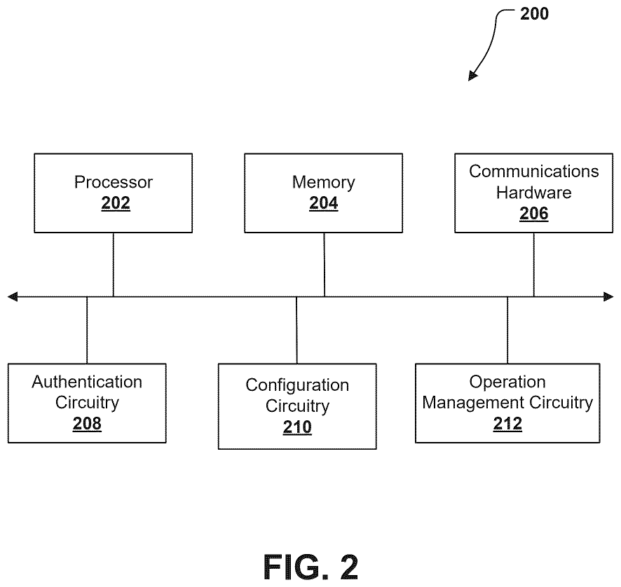

The passkey authentication system 102 may be implemented as one or more computing devices or servers, which may be composed of a series of components. Particular components of the passkey authentication system 102 are described in greater detail below with reference to the apparatus 200 in connection with FIG. 2.

The primary user device 106 and/or the one or more guardian user devices (e.g., any one of the guardian user devices 108A-108N) may be embodied by any computing devices known in the art (e.g., mobile phone, personal computer). The primary user device 106 and/or guardian user devices (e.g., any one of the guardian user devices 108A-108N) may not be an independent device but may be a peripheral device communicatively coupled to other computing devices. In some embodiments, the primary user device 106 and/or a guardian user device (e.g., any one of the guardian user devices 108A-108N) may be associated with a primary user who is associated with a primary user account maintained by the passkey authentication system 102 (e.g., a customer). In some embodiments, a guardian user device (e.g., any one of the guardian user devices 108A-108N) may be associated with a guardian user who is different than the primary user. In some embodiments, the guardian user may be associated with a guardian user account maintained by the passkey authentication system 102 (e.g., a customer).

### Example Implementing Apparatuses

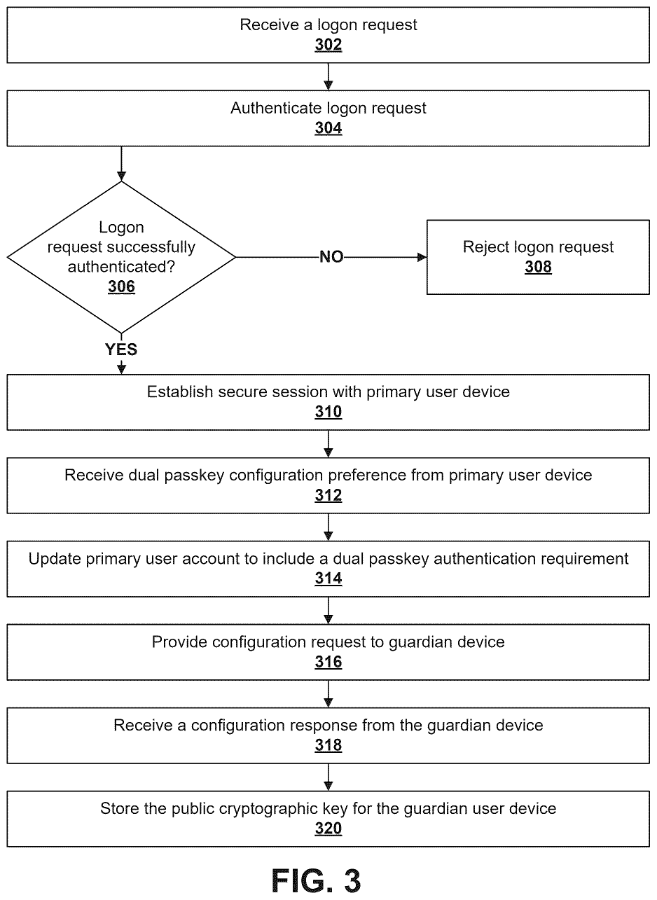

The passkey authentication system 102 (described previously with reference to FIG. 1) may be embodied by one or more computing devices or servers, shown as the apparatus 200 in FIG. 2. The apparatus 200 may be configured to execute various operations described above in connection with FIG. 1 and below in connection with FIGS. 3-8. As illustrated in FIG. 2, the apparatus 200 may include the processor 202, the memory 204, the communications hardware 206, the authentication circuitry 208, the configuration circuitry 210, and the operation management circuitry 212, each of which will be described in greater detail below.

The processor 202 (and/or co-processor or any other processor assisting or otherwise associated with the processor) may be in communication with the memory 204 via a bus for passing information among components of the apparatus. The processor 202 may be embodied in a number of different ways and may, for example, include one or more processing devices configured to perform independently. Furthermore, the processor 202 may include one or more processors configured in tandem via a bus to enable independent execution of software instructions, pipelining, and/or multithreading. The use of the term “processor” may be understood to include a single core processor, a multicore processor, multiple processors of the apparatus 200, remote or “cloud” processors, or any combination thereof.

The processor 202 may be configured to execute software instructions stored in the memory 204 or otherwise accessible to the processor 202. In some cases, the processor 202 may be configured to execute hard-coded functionality. As such, whether configured by hardware or software methods, or by a combination of hardware with software, the processor 202 represents an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, software instructions, or the like, for enabling the apparatus 200 to carry out various functions in accordance with example embodiments contemplated herein.

The communications hardware 206 may be any means, such as a device or circuitry embodied in either hardware or a combination of hardware and software, that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., the memory 204) accessible to the processor 202.

In addition, the apparatus 200 further comprises the authentication circuitry 208, which may configured to determine a passkey authentication requirement, perform a dual passkey authentication routine, authenticate a first digital signature, authenticate a second digital signal, and/or the like. In some embodiments, the authentication circuitry 208 may further be configured to generate a first challenge, authenticate a first digital signature, generate a second challenge, authenticate a second digital signature, and/or the like. In some embodiments, the authentication circuitry 208 may further be configured to determine a location of a primary user device, determine a location of a guardian user device, determine whether the location of the guardian user device is within a proximity threshold from the location of the primary user device, and/or the like. The authentication circuitry 208 may utilize the processor 202, the memory 204, or any other hardware component included in the apparatus 200 to perform these operations, as described in connection with FIGS. 3-8 below. The authentication circuitry 208 may further utilize the communications hardware 206 to gather data from a variety of sources (e.g., any one of the primary user device 106 and/or the guardian user devices 108A-108N, as shown in FIG. 1) and/or exchange data with a primary user and/or guardian user. The authentication circuitry 208 may further utilize the communications hardware 206 to gather data from a variety of sources.

In addition, the apparatus 200 may further comprise the configuration circuitry 210, which may be configured to select a guardian user device, identify an availability schedule for guardian user devices, update a primary user account, and/or the like. The configuration circuitry 210 may utilize the processor 202, the memory 204, or any other hardware component included in the apparatus 200 to perform these operations, as described in connection with FIGS. 3-8 below. The configuration circuitry 210 may further utilize the communications hardware 206 to gather data from a variety of sources (e.g., any one of the primary user device 106 and/or the guardian user devices 108A-108N, as shown in FIG. 1) and/or exchange data with a primary user and/or guardian user. The configuration circuitry 210 may further utilize the communications hardware 206 to gather data from a variety of sources.

In addition, the apparatus 200 may further comprise the operation management circuitry 212, which may be configured to perform an operational routine. The operation management circuitry 212 may utilize the processor 202, the memory 204, or any other hardware component included in the apparatus 200 to perform these operations, as described in connection with FIGS. 3-8 below. In various embodiments, the operation management circuitry 212 may further utilize the communications hardware 206 to gather data from a variety of sources (e.g., any one of the primary user device 106 and/or the guardian user devices 108A-108N, as shown in FIG. 1) and/or exchange data with a primary user and/or guardian user. The operation management circuitry 212 may further utilize the communications hardware 206 to gather data from a variety of sources.

Although components 202-212 are described in part using functional language, it will be understood that the particular implementations necessarily include the use of particular hardware. It should also be understood that certain of these components 202-212 may include similar or common hardware. For example, the authentication circuitry 208, the configuration circuitry 210, and the operation management circuitry 212 may each, at times, leverage use of the processor 202, the memory 204, or the communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus 200 therefore shall be interpreted as necessarily including the particular hardware configured to perform the functions associated with the particular element being described. Of course, while the term “circuitry” should be understood broadly to include hardware, in some embodiments, the term “circuitry” may in addition refer to software instructions that configure the hardware components of the apparatus 200 to perform the various functions described herein.

Although the authentication circuitry 208, the configuration circuitry 210, and the operation management circuitry 212 may leverage the processor 202, the memory 204, or the communications hardware 206 as described above, it will be understood that any of the authentication circuitry 208, the configuration circuitry 210, and the operation management circuitry 212 may include one or more dedicated processors, specially configured field programmable gate arrays, or application-specific interface circuits to perform its corresponding functions and may accordingly leverage the processor 202 executing software stored in a memory (e.g., the memory 204) or the communications hardware 206 for enabling any functions not performed by special-purpose hardware. In all embodiments, however, it will be understood that the authentication circuitry 208, the configuration circuitry 210, and the operation management circuitry 212 comprise particular machinery designed for performing the functions described herein in connection with such elements of the apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of the apparatus 200. Similarly, some or all of the functionality described herein may be provided by third-party circuitry. For example, a given apparatus 200 may access one or more third-party circuitries in place of local circuitries for performing certain functions.

As will be appreciated based on this disclosure, example embodiments contemplated herein may be implemented by the apparatus 200. Furthermore, some example embodiments may take the form of a computer program product comprising software instructions stored on at least one non-transitory computer-readable storage medium (e.g., the memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by the apparatus 200 as described in FIG. 2, that loading the software instructions onto a computing device or apparatus produces a special-purpose machine comprising the means for implementing various functions described herein.

Having described specific components of the example apparatus 200, example embodiments are described below in connection with a series of flowcharts.

### Example Passkey Authentication System Operations

Turning to FIGS. 3-8, example flowcharts are illustrated that contain example operations implemented by example embodiments described herein. The operations illustrated in FIGS. 3-8 may, for example, be performed by the passkey authentication system 102 shown in FIG. 1, which may in turn be embodied by the apparatus 200, which is shown and described in connection with FIG. 2. To perform the operations described below, the apparatus 200 may utilize one or more of the processor 202, the memory 204, the communications hardware 206, the authentication circuitry 208, the configuration circuitry 210, the operation management circuitry 212, and/or any combination thereof. It will be understood that user interaction with the passkey authentication system 102 may occur directly via the communications hardware 206 or may instead be facilitated by a separate user device (e.g., primary user device 106 and/or any one of the guardian user devices 108A-108N), as shown in FIG. 1.

### Example Operations for Configuring a Primary User Account with a Dual Passkey Authentication Requirement

Turning first to FIG. 3, example operations are shown for configuring a primary user account with a dual passkey authentication requirement.

As shown by operation 302, the apparatus 200 includes means, such as the communications hardware 206 or the like, for receiving a logon request for the primary user account. The communications hardware 206 may receive a logon request from a user device, such as the primary user device 106, when a primary user attempts to log into a primary user account using an associated software application. In some embodiments, the logon request may be a request to access the primary user account within the software application. In some embodiments, the software application is a mobile application or a native application that is configured to execute on the primary user device 106 (or any other user device, such as guardian user devices 108A-108N).

The logon request may include a candidate user identifier (e.g., a username, email, customer number, and/or the like) and candidate user credentials (e.g., a password, biometric data, personal identification number (PIN), and/or the like). Additionally, or alternatively, the logon request may include an indication of the primary user device 106. For example, the logon request may include a device identifier, such as a media access control (MAC) address, an Internet Protocol (IP) address, international mobile equipment identifier (IMEI) number, phone number, a mobile equipment identifier (MEID), a unique device identifier (UDID), a hardware identifier, an electronic serial number, or any other identifier that uniquely identifies the particular user device. In some embodiments, the logon request may be received using a hypertext transfer protocol (HTTP) or HTTP secure (HTTPS) protocol (e.g., an HTTP/HTTPS request). In some embodiments, the communications hardware 206 may receive the logon request using specific application program interfaces (APIs), such as representational state transfer APIs (RESTful APIs) or WebSocket APIs.

As shown by operation 304, the apparatus 200 includes means, such as the memory 204, the communications hardware 206, the authentication circuitry 208, or the like, for authenticating the logon request based on user credentials provided in the logon request. The authentication circuitry 208 may authenticate the logon request for the primary user account as received from the primary user device 106 using the candidate user credentials provided in the logon request and stored user credentials associated with the primary user account. In particular, the authentication circuitry 208 may use the candidate user identifier to identify a corresponding primary user account and determine stored user credentials associated with the primary user account. In an instance in which the received candidate user credentials sufficiently correspond or match corresponding stored user credentials, the authentication circuitry 208 may successfully authenticate the primary user and the logon request. Alternatively, in an instance in which the received candidate user credentials fail to sufficiently correspond to or match the stored user credentials, the authentication circuitry 208 may fail to authenticate the primary user and the logon request.

The authentication circuitry 208 may authenticate the logon request based on the user credential type of the candidate user credential received in the logon request. For example, the candidate user credential may correspond to a user credential type, such as a passkey, password, biometric data, PIN, etc. The authentication circuitry 208 may be configured to identify the user credential type of the candidate user credential in the logon request and then perform an authentication protocol based on the user credential type. In some embodiments, the particular authentication protocol used to authenticate the logon request may be stored in an associated memory, such as the memory 204. The authentication protocol may describe operations the authentication circuitry 208 may perform to authenticate the logon request, including algorithms or models used in the authentication, various thresholds (e.g., a similarity score threshold), a number of logon request reattempts able to be received from the primary user device 106, and/or the like.

For example, for a candidate user credential that is a password, the authentication circuitry 208 may use a hashing function to hash the characters of the candidate password and then compare the hashed candidate password to a hashed stored password. In an instance in which the corresponding characters of the hashed candidate password and hashed stored password exactly match, the authentication circuitry 208 may determine the candidate user credentials sufficiently match the stored user credentials.

In some embodiments, the authentication circuitry 208 may use one or more models to determine whether the candidate user credentials sufficiently match the stored user credentials. For example, in an instance in which a candidate user credential corresponds to biometric data (e.g., fingerprint data, facial image data, retina data, or the like), the authentication circuitry 208 may be configured to use one or more biometric matching machine-learning models to determine a similarity score between the biometric data of the candidate user credential and the corresponding biometric data of the stored user credential. In an instance in which the similarity score satisfies one or more similarity thresholds, the authentication circuitry 208 may determine that the candidate user credential sufficiently matches the stored user credential.

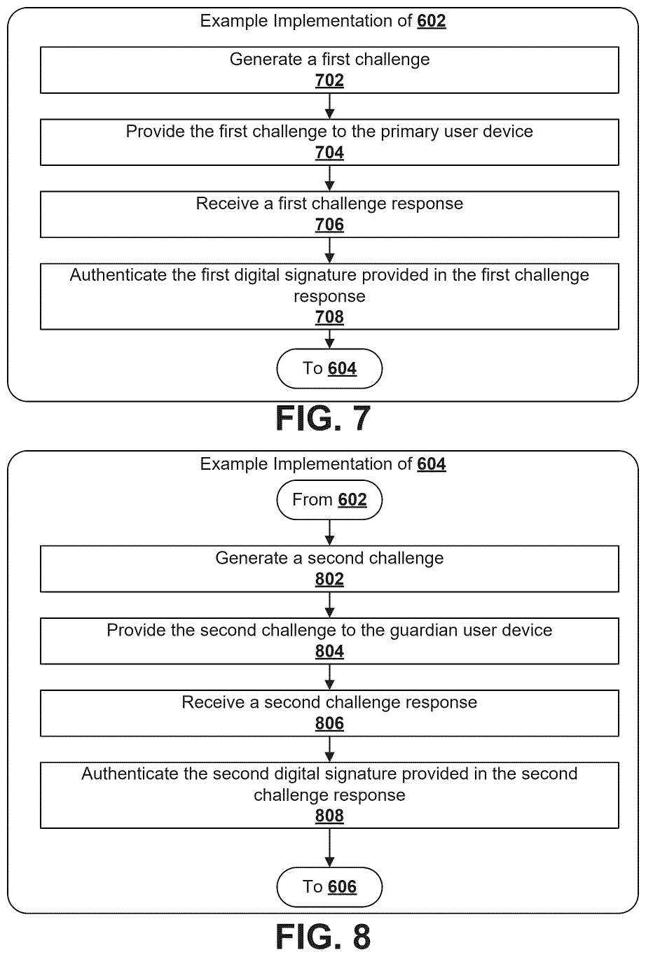

In some embodiments, the primary user device 106 may have established a passkey with the apparatus 200. That is, the primary user device 106 may store or have access to a private cryptographic key and the apparatus 200 may store or have access to a corresponding public cryptographic key. In some embodiments, the primary user device 106 may be associated with a device profile that is stored in or otherwise associated with the primary user account. The device profile for the primary user device 106 may include device information pertaining to the primary user device 106, such as an associated phone number and/or associated device identifiers. Additionally, the device profile may include an indication of the owner of the user device, such as by including the user identifier of the primary user. In some embodiments, the device profile for the primary user device 106 may be linked or associated with the corresponding public cryptographic key stored by the apparatus 200, such as in the memory 204. The authentication circuitry 208 may authenticate the logon request using the passkey for the primary user device 106 in a substantially similar manner, as will be described in FIG. 7.

As shown by operation 306, the apparatus 200 includes means, such as the authentication circuitry 208 or the like, for determining whether the logon request was successfully authenticated. As described in operation 304, the authentication circuitry 208 may authenticate the logon request based on the candidate user credential included in the logon request. If the authentication circuitry 208 fails to authenticate the logon request, the authentication circuitry 208 may reject the logon request, as described in operation 308. If the authentication circuitry 208 successfully authenticates the logon request, the communications hardware 206 may establish a secure session with the primary user device 106, as described in operation 310.

If the logon request fails to be successfully authenticated, the process may proceed to operation 308. As shown by operation 308, the apparatus 200 includes means, such as the communications hardware 206, the authentication circuitry 208, or the like, for rejecting the logon request. If the logon request fails to be authenticated, the authentication circuitry 208 may be unable to verify the identity of the primary user and thus will not establish a secure session nor provide user account information to the primary user device 106. Thus, the user will not be able to configure his/her primary user account with a dual passkey authentication requirement. In this way, the security of the primary user account is maintained by prohibiting the primary user account from being configured with a dual passkey authentication requirement unless the logon request is successfully authenticated, thereby indicating confirmation of the requesting user identity.

In some embodiments, the authentication circuitry 208 may generate a denial message and use the communications hardware 206 to provide the denial message to the primary user device 106. The denial message may include feedback on why the logon request has been denied. For example, the denial message may indicate that the provided password does not match a stored password or a primary user account associated with the user credential cannot be found. In some embodiments, the denial message may prompt the primary user to retry the logon process. The primary user may reattempt a logon request a threshold number of times (e.g., as defined by the authentication protocol) before the primary user account is locked.

If the logon request was successfully authenticated, the process may proceed to operation 310. As shown by operation 310, the apparatus 200 includes means, such as the memory 204, the communications hardware 206, the authentication circuitry 208, or the like, for establishing a secure session with the primary user device. Once the logon request has been successfully authenticated, the authentication circuitry 208 may generate a session token that can be used to track a primary user's session until the session expires or the user logs out of the software application. The authentication circuitry 208 may store this session token in a memory, such as the memory 204, and may provide the session token to the primary user device 106 using the communications hardware 206. The communications hardware 206 may provide the session token in a response (e.g., an HTTP/HTTPS response), which may also include user account data for the user account, to the software application running on the primary user device 106. In some embodiments, the communications hardware 206 may use specific APIs, such as RESTful APIs or WebSocket APIs, to provide primary user account data to the software application.

Once the session token and primary user account data are provided to the software application running on the primary user device 106, an authenticated session may be successfully established. The authenticated session may continue until a termination event occurs. A termination event may be the user logging out of the session. Alternatively, the termination event may be a timeout event, where the software application running on the primary user device 106 experiences a period of inactivity for a length of time that exceeds an inactivity time threshold (e.g., 10 minutes). Alternatively, a termination event may be the expiration of the session token. In an instance a termination event occurs, the primary user may be required to provide another logon request to establish a new authenticated session or reestablish the authenticated session.

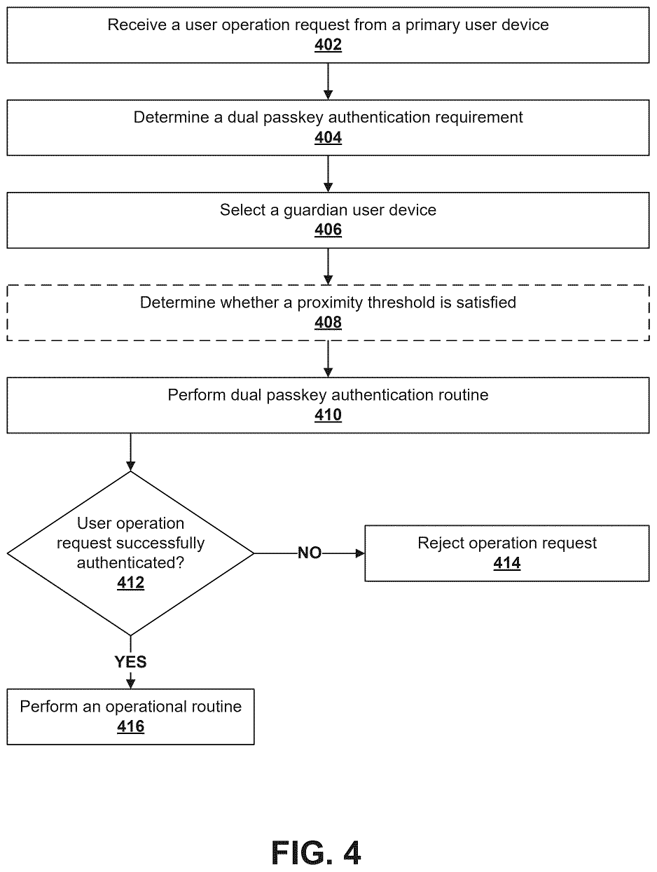

As shown by operation 312, the apparatus 200 includes means, such as the communications hardware 206, the configuration circuitry 210, or the like, for receiving a dual passkey configuration preference from the primary user device. The communications hardware 206 may receive the dual passkey configuration preference from the primary user device 106 during the secure session. In some embodiments, the dual passkey configuration preference may be received in a dual passkey configuration request. The primary user may wish to configure his/her primary account with a dual passkey configuration requirement and thus may submit the dual passkey configuration request that includes a dual passkey configuration preference via primary user device 106. By configuring a primary user account with a dual passkey configuration preference, this may cause the primary user account to be configured with a dual passkey authentication requirement. As described in further detail in FIG. 4, a primary user account that is configured with a dual passkey authentication requirement requires verification of both the primary user device and a guardian user device in order to authenticate a user operation request. Thus, the dual passkey authentication requirement provides for enhanced security around the primary user account. Additionally, in some embodiments, the dual passkey authentication requirement may enable certain user operation requests to be authenticated that would otherwise not be authenticated. For example, the dual passkey authentication requirement may enable a primary user to perform a user operation request for a fund transfer above a fund limit. Thus, the primary user may wish to configure his/her primary user account with a dual passkey authentication requirement.

In some embodiments, the primary user may enable the dual passkey authentication requirement for the primary user account by providing a dual passkey configuration request. In some embodiments, the dual passkey configuration request may be provided in response to the primary user entering input into the associated software application and causing the primary user device 106 to provide the dual passkey configuration request. The dual passkey configuration request may include one or more dual passkey configuration preferences for the primary user account. In some embodiments, a dual passkey configuration preference may be indicative of a request to configure the primary user account with a dual passkey authentication requirement for an operation request type. In some embodiments, an operation request type may describe a particular type of user operation request that is associated with a particular operational routine. For example, an operation request type may be a user account logon request, a fund transfer request, a user account update request, an account opening request, and/or the like. In some embodiments, the primary user may select one or more user operation types to associate with a dual passkey authentication requirement that may be reflected as dual passkey configuration preferences. The dual passkey configuration request may therefore include one or more dual passkey configuration preferences that are indicative of the one or more selected operation request types. Additionally, or alternatively, the dual passkey configuration preference may allow the primary user to configure a condition under which the dual passkey authentication requirement should be enabled for a specific operation request type. For example, the dual passkey configuration preference may describe that a fund transfer request over the amount of $500 be associated with a dual passkey authentication requirement. In some embodiments, the primary user may not be required to manually select the operation request type. Instead, the dual passkey configuration request may include an indication (e.g., a binary indicator, flag, or the like) that the primary user would like to configure his/her primary user account with a dual authentication passkey requirement.

In some embodiments, the dual passkey configuration request may additionally, or alternatively, include an indication of one or more guardian user devices. Guardian user devices may be a user device that is different than the primary user device 106. The primary user may provide an indication of one or more guardian user devices that he/she would like to associate with the primary user account. As described in more detail in FIG. 4, a guardian user device associated with the primary user account may be used during a dual passkey authentication routine to authenticate a user operation request. In order for a guardian user device to be used in a dual passkey authentication routine, the primary user may be required to configure the primary user account with the guardian user device. In some embodiments, the indication of the guardian user device may be provided as a phone number or a device identifier of a desired guardian user device. For example, a device identifier may be a MAC address, an IP address, an IMEI number, a phone number, an MEID, a UDID, a hardware identifier, an electronic serial number, or any other identifier that uniquely identifies the particular guardian user device.

In some embodiments, a guardian user device may be associated with the primary user. For example, the guardian user device 108A may be a laptop, tablet, smartphone, wearable device, and/or the like that is owned by the primary user. Alternatively, a guardian user device may be associated with a guardian user that is an individual other than the primary user. For example, a guardian user may be an individual, such as a family member, friend, caregiver, professional, etc., who is trusted by the primary user. Thus, a guardian user device, such as the guardian user device 108N, may be a laptop, tablet, smartphone, wearable device, and/or the like that is owned by the guardian user.

In some embodiments, the dual passkey configuration request may include an indication of the conditions under which a particular guardian user device can be used in the dual passkey authentication routine. For example, the dual passkey configuration request may include an indication of the guardian user device 108A and the guardian user device 108N. The dual passkey configuration request may further indicate that the guardian user device 108A may be used for any operation request type, but the guardian user device 108N may only be used for a fund transfer operation request type.

As shown by operation 314, the apparatus 200 includes means, such as the configuration circuitry 210 or the like, for updating the primary user account to include a dual passkey authentication requirement. Upon receipt of the dual passkey configuration request, the communications hardware 206 may provide the dual passkey configuration request to the configuration circuitry 210. The configuration circuitry 210 may then update the primary user account to include the dual passkey authentication requirement for one or more operation request types. The configuration circuitry 210 may add an indicator, such as a flag, permission requirement, rule, parameter, and/or the like, to the primary user account to reflect that the primary user account is configured with a dual passkey authentication requirement. Thus, upon receipt of a subsequent user operation request for the primary user account, the user operation request may be evaluated to determine whether a dual passkey authentication routine is required.

In addition to the dual passkey authentication indicator, the primary user account may be updated to reflect the particular operation request types that require a dual passkey authentication routine. If the dual passkey configuration request included operation request types and/or conditions or parameters selected by the primary user, the configuration circuitry 210 may generate one or more rules and/or permissions that describe a dual passkey authentication requirement for each selected operation request type. If the dual passkey configuration request includes conditions for an operation request type, the configuration circuitry 210 may further generate one or more rules for the particular operation request type that indicate a dual passkey authentication requirement for the operation request type under select conditions. If the dual passkey configuration request did not include manually selected operation request types and/or parameters, the configuration circuitry 210 may generate one or more default rules and/or permissions for the primary user account. Thus, the primary user account may be updated to include an indicator that the primary user account is associated with a dual passkey authentication requirement, and additionally, the primary user account may be updated to be associated with or otherwise include one or more rules and/or permissions that control what operation request types require a dual passkey authentication routine.

As shown by operation 316, the apparatus 200 includes means, such as the communications hardware 206, the configuration circuitry 210, or the like, for providing a configuration request to the guardian user device. As described above, the primary user account is associated with a dual passkey authentication requirement that will result in the performance of a dual passkey authentication routine for qualifying user operation requests. In order for a dual passkey authentication routine to be performed successfully, the primary user account must be associated with at least one guardian user device, and said guardian user device must establish a passkey with the apparatus 200 or an associated device such that the guardian user device can be authenticated. Thus, the configuration circuitry 210 may generate a configuration request that the communications hardware 206 may provide to the guardian user device.

In some embodiments, the dual passkey configuration preference may include an indication of a guardian user device to be associated with the primary user account. Alternatively, the primary user may provide the indication of a guardian user device in a separate communication during a secure session. As described above, the indication of the guardian user device may be provided as a phone number or a device identifier of a desired guardian user device. For example, a device identifier may be a MAC address, an IP address, an IMEI number, a phone number, an MEID, a UDID, a hardware identifier, an electronic serial number, or any other identifier that uniquely identifies the particular guardian user device.

In some embodiments, the communications hardware 206 may provide the configuration request directly to the guardian user device. For example, if the guardian user device is a smartphone with an associated phone number, the communications hardware 206 may provide the configuration request to the guardian user device via short message service. Additionally, or alternatively, the configuration circuitry 210 may determine whether the device identifier matches an existing device identifier associated with a user account (e.g., a primary user account or another user account). If so, the configuration circuitry 210 may determine whether the guardian user device is configured with an associated software application. If the guardian user device is configured with an associated software application, the communications hardware 206 may provide the configuration request as a push notification.

In some embodiments, the communications hardware 206 may indirectly provide the configuration request to the guardian user device. In particular, in some embodiments, the communications hardware 206 may provide the configuration request to the primary user device 106, which, in turn, may provide the configuration request to the guardian user device, such as via Bluetooth, via near-field communication, over Wi-Fi, and/or the like. In some embodiments, this method of indirect provisioning of the configuration request may be particularly beneficial for security purposes, as it requires the guardian user device and the primary user device to be located proximately to one another. Thus, the primary user has precise and manual control over the guardian user device that will be included in the primary user account.

In some embodiments, the configuration request may authorize, request, or otherwise instruct the guardian user device to generate and/or establish a passkey with the apparatus 200. In particular, the configuration request may request the guardian user device generate a public cryptographic key and private cryptographic key that form a passkey and, further, may request the guardian user device provides the public cryptographic key of the passkey to the communications hardware 206. In some embodiments, the guardian user device may use third-party software to generate the passkey and/or output the public cryptographic key and private cryptographic key. The guardian user device may store the private cryptographic key and provide the public cryptographic key to the communications hardware 206 in a configuration response.

The passkey generated by the guardian user device may be specific and uniquely associated with the primary user account. In some embodiments, the configuration request may include a unique identifier that corresponds to the primary user account, and the guardian user device may associated with a stored private cryptographic key with this unique identifier. Thus, the guardian user device may select the appropriate private cryptographic key to sign a challenge during a dual passkey authentication routine, even when the challenge is received from a device (e.g., the apparatus 200) with which the guardian user device may have established other passkeys with. For example, if the guardian user device is owned by a guardian user different than the primary user, the guardian user device may store a private cryptographic key associated with a corresponding guardian user account as well as a private cryptographic key associated with the primary user account without the passkeys conflicting. This also ensures that the security around the guardian user account is maintained but still allows the guardian user device to be used during the dual passkey authentication routine. Additionally, the particular passkey associated with the guardian user device may be associated with restricted permissions such that the guardian user may only use the passkey during the dual passkey authentication routine but cannot use the passkey to access the primary user account.

In some embodiments, the configuration request may further include a request for an availability schedule for the candidate guardian user device. An availability schedule may be indicative of when the guardian user device is available for use during a dual passkey authentication routine. For example, the available schedule may be indicative of days and/or times that the guardian user device is available or unavailable. Thus, the owner of the guardian user device (e.g., the primary user or a guardian user) may provide an indication of his/her availability such that the guardian user device is selected for the dual passkey authentication routine only when available.

In some embodiments, the configuration request may also allow an owner of the guardian user device (e.g., a primary user or a guardian user) to provide a user identifier (e.g., an associated username, email, customer number, and/or the like). Furthermore, the configuration request may also allow for the owner of the guardian user device to select whether he/she is the primary user or a different user.

As shown by operation 318, the apparatus 200 includes means, such as the communications hardware 206, the authentication circuitry 208, the configuration circuitry 210, or the like, for receiving a configuration response from the guardian user device. The communications hardware 206 may receive the configuration response from the guardian user device. The configuration response may include the public cryptographic key of the passkey for the guardian user device. Thus, this may enable the guardian user device to be used during a dual passkey authentication routine for subsequent user operation requests for the primary user account. In some embodiments, the received public cryptographic key may also be associated with the unique identifier that corresponds to the primary user account. Thus, this unique identifier may be provided with the challenge sent to the guardian user device during the dual passkey authentication routine to enable the guardian user device to select the appropriate private cryptographic key.

In some embodiments, the configuration response may be encrypted by the guardian user device. In some embodiments, prior to providing the configuration request, the authentication circuitry 208 may use communications hardware 206 and the guardian user device may establish a shared cryptographic key, such as by using the Diffie-Hellman Key Exchange, Elliptic-Curve Diffie-Hellman, using a pre-shared key, using quantum key distribution, and/or the like. Thus, the guardian user device may encrypt at least a portion of the configuration response (e.g., the public cryptographic key), and the authentication circuitry 208 may decrypt the configuration response using the shared cryptographic key. Other suitable protection measures that can securely provide the public cryptographic key may also contemplated.

In some embodiments, the configuration response may further include an availability schedule for the guardian user device. In some embodiments, the configuration circuitry 210 may create a device profile for the guardian user device, and this profile may be included in or otherwise associated with the primary user account. The device profile may include corresponding device information pertaining to the guardian user device, such as an associated phone number and/or associated device identifiers. The device profile may further include the availability schedule for the guardian user device, if an availability schedule was provided. Additionally, the device profile may include an indication of the owner of the user device, such as the user identifier and/or an indication of whether the owner is the primary user or a guardian user (e.g., not the primary user).

As shown by operation 320, the apparatus 200 includes means, such as the communications hardware 206, the authentication circuitry 208, or the like, for storing the public cryptographic key for the guardian user device. The authentication circuitry 208 may store the public cryptographic key for the guardian user device in an associated memory, such as in the memory 204. In some embodiments, the public cryptographic key may be stored in a repository that implements a public key infrastructure. In some embodiments, the public cryptographic key is associated with the corresponding device profile of the guardian user device. In some embodiments, the public cryptographic key may be stored in an encrypted or otherwise protected format.

Additionally, the authentication circuitry 208 may associate the stored public cryptographic key for the guardian user device with limited or restricted permissions. That is, the authentication circuitry 208 may designate the specific public cryptographic key as associated with a guardian device. Thus, the guardian device may not use the public cryptographic key to access the primary user account. This ensures the primary user account remains secure and prevents unauthorized access while still allowing for a dual passkey authentication routine to be performed with the guardian user device.

### Example Operations for Authenticating a User Operation

Turning now to FIG. 4, example operations are shown for authenticating a user operation request using a dual passkey authentication routine.

As shown by operation 402, the apparatus 200 includes means, such as the communications hardware 206, the authentication circuitry 208, or the like, for receiving a user operation request. In some embodiments, the communications hardware 206 may receive the user operation request from the primary user device 106. In some embodiments, the communications hardware 206 may receive the user operation request from the primary user device 106 during a secure session. The secure session may be established as described in operations 302-310 of FIG. 3. Alternatively, the communications hardware 206 may receive the user operation request from the primary user device 106 without the primary user device 106 having established a secure session. In some embodiments, the user operation request may be a logon request. In some embodiments, the user operation request may be received using a HTTP/HTTPS protocol (e.g., an HTTP/HTTPS request) or using an API.

A user operation request may describe a requested operation to be performed for the particular primary user account. In some embodiments, the user operation request may correspond to an operation request type. An operation request type may correspond to a particular category of predefined user request types. Each operation request type may be associated with an operational routine. Before an operational routine can be performed, the user operation request may first need to be authenticated using a dual passkey authentication routine.

For example, an operation request type may be a user account logon request, a fund transfer request, a user account update request, an account opening request, and/or the like. A received user operation request may further include user-supplied data for the particular user operation request. The user-supplied data may be dependent upon the operation request type. By way of continuing example, user-supplied data for a logon request may include a candidate user identifier. As another example, user-supplied data for a fund transfer request may include a provisioning account, a recipient account, a fund amount, and a memo line. As another example, user-supplied data for a user account update request may include a user input value for a particular user account data field (e.g., legal name, residential address, work address, phone number, trusted user devices, trusted locations, or the like). As another example, user-supplied data for an account opening request may include various demographic information, a social security number, a phone number, an email address, etc. In some embodiments, the user may provide the user-supplied information to the primary user device 106 within the associated software application. In turn, the associated software application may provide the specific information from the primary user associated with the user operation request.

The user operation request may further pertain to the primary user account. In some embodiments, in an instance in which a secure session is currently established with the primary user device 106, the session token may identify the corresponding primary user account. Additionally, or alternatively, the user operation request may include an account identifier, such as a candidate user identifier, which the authentication circuitry 208 (or another circuitry of the apparatus 200) may use to identify the primary user account.

Additionally, in some embodiments, the user operation request may identify the primary user device from which the user operation request is received from. For example, the user operation request may be a device identifier of the primary user device 106, such as a MAC address, an IP address, an IMEI number, a phone number, an MEID, a UDID, a hardware identifier, an electronic serial number, etc. The apparatus 200 may use this information to identify a corresponding device profile for the primary user device 106.

As shown by operation 404, the apparatus 200 includes means, such as the authentication circuitry 208 or the like, for determining a dual passkey authentication requirement. In some embodiments, the authentication circuitry 208 may determine whether the primary user account is associated with a dual passkey authentication requirement. For example, as described in FIG. 3, the primary user account may include an indicator, such as a flag, permission requirement, rule, parameter, and/or the like, that indicates that the primary user account is associated with a dual passkey authentication requirement. Additionally, the primary user account may include particular operation request types and/or conditions that are associated with a dual passkey authentication requirement. The authentication circuitry 208 may identify the operation request type of the user operation request and determine whether the operation request type is associated with a dual passkey authentication requirement in the primary user account. If the operation request type is associated with a dual passkey authentication requirement, the process may proceed to operation 406. If the operation request type is not associated with a dual passkey authentication requirement, the process for authenticating and/or performing the user operation request may proceed in a conventional manner.

If the operation request type is associated with certain conditions, the authentication circuitry 208 may determine whether the current dual passkey authentication requirement satisfies those conditions. For example, a condition for a fund transfer operation request type may be that the fund transfer include a fund amount over $500. Thus, if the user operation request received in operation 402 corresponds to a fund transfer operation request type and involves a fund amount over $500, the authentication circuitry 208 may determine a dual passkey authentication requirement is activated.

As shown by operation 406, the apparatus 200 includes means, such as the memory 204, the configuration circuitry 210, or the like, for selecting a guardian user device. Once the authentication circuitry 208 has determined a dual passkey authentication requirement, the configuration circuitry 210 may select a guardian user device that will be used for the dual passkey authentication routine. In some embodiments, the primary user account may be associated with one or more guardian user devices. Thus, the configuration circuitry 210 may select one of the guardian user devices.

In some embodiments, the primary user may provide a preference ranking for each guardian user device. The preference ranking for a given guardian user device may be indicative of a particular preference for the given guardian user device to be used for the dual passkey authentication routine. For example, the guardian user device 108A may be associated with a preference ranking of “one,” which is indicative that the guardian user device 108A is the top preference as chosen by the primary user. The guardian user device 108N may be associated with a preference ranking of “two,” which is indicative that guardian user device 108N is the second-most preferable guardian user device as chosen by the primary user.

In some embodiments, a device profile for the guardian user devices may include an availability schedule that is indicative of when the particular guardian user device is available to be used in the dual passkey authentication routine. Thus, the configuration circuitry 210 may determine a current time and/or date and use the availability schedule of the guardian user device to determine whether it is available for use. In some embodiments, the configuration circuitry 210 may use the availability schedule of candidate guardian user devices to filter available candidate guardian user devices. Thus, only available guardian user devices may be selected.

In some embodiments, the configuration circuitry 210 may select the guardian user device based on the operation request type of the user operation request. In some embodiments, an operation request type may further be associated with one or more rules that control what guardian user devices can participate in the dual passkey authentication routine. In some embodiments, the one or more rules for a given operation request type are defined by a permissioned user associated with the apparatus 200 (e.g., an administrator, a compliance officer, or the like). For example, a rule for a user operation may require that only certain guardian user devices of a particular user device type can be selected, certain guardian user devices of a particular user device type cannot be selected, the guardian user device must be associated with the primary user, the guardian user device must be associated with a user different than the primary user (e.g., a guardian user), and/or the like. Thus, the configuration circuitry 210 may select the guardian user device based on the one or more rules associated with the operation request type.

Optionally, as shown by operation 408, the apparatus 200 includes means, such as the authentication circuitry 208 or the like, for determining whether a proximity threshold is satisfied. In some embodiments, the one or more rules for a given operation request type and/or under certain conditions may require that the guardian user device and primary user device be located within a proximity threshold from one another. This may increase the confidence that the primary user device and guardian user device are legitimately associated with one another and thus enhance security around the user operation request. If the location of the guardian user device is within a proximity threshold from the location of the primary user device, then the process may proceed to operation 410. Otherwise, if the one or more rules require that the guardian user device and primary user device are located within a proximity threshold from one another, the process may proceed to operation 414.

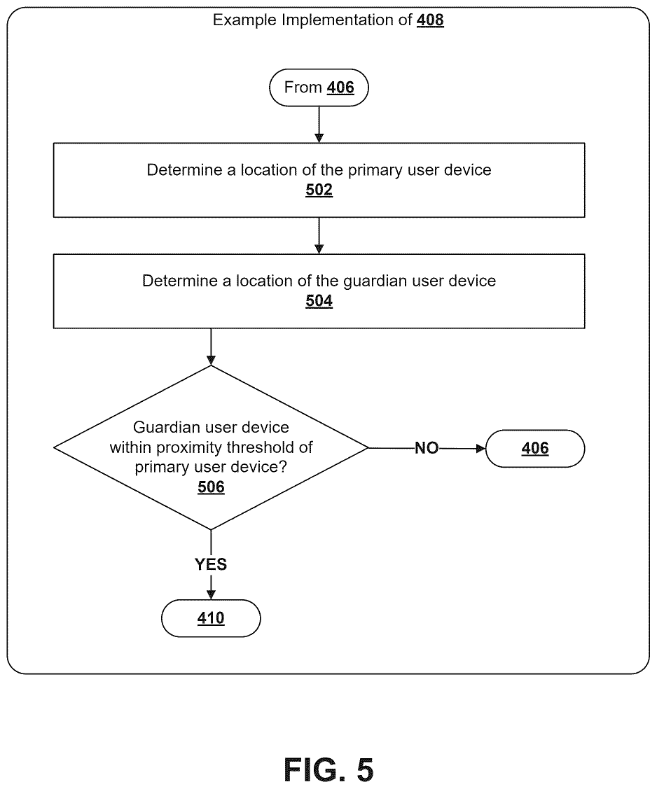

In some embodiments, operation 408 may be performed in accordance with the operations described by FIG. 5. Turning now to FIG. 5, example operations are shown for determining whether a proximity threshold is satisfied.

As shown by operation 502, the apparatus 200 includes means, such as the communications hardware 206, the authentication circuitry 208, or the like, for determining a location of the primary user device. In some embodiments, the primary user device may provide its location in the user operation request, and the authentication circuitry 208 may determine the location of the primary user device from the user operation request received in operation 402. Alternatively, the authentication circuitry 208 may cause the communications hardware 206 to request location data from the primary user device. The primary user device may respond to the request and provide its location data to the communications hardware 206 in a communication other than in the user operation request. The authentication circuitry 208 may receive the location data from the communications hardware 206. In some embodiments, the primary user device may be configured to share its location data with the communications hardware 206 during a secure session. In some embodiments, the location data may be global positioning system (GPS) coordinates, a current IP address, and/or the like.

As shown by operation 504, the apparatus 200 includes means, such as the communications hardware 206, the authentication circuitry 208, or the like, for determining a location of the guardian user device. In some embodiments, the authentication circuitry 208 may cause the communications hardware 206 to request location data from the guardian user device. The guardian user device may respond to the request and provide its location data to the communications hardware 206. The authentication circuitry 208 may receive the location data from the communications hardware 206. In some embodiments, the location data may be GPS coordinates, a current IP address, and/or the like.

As shown by operation 506, the apparatus 200 includes means, such as the authentication circuitry 208 or the like, for determining whether the location of the guardian user device is within a proximity threshold from the location of the primary user device. Once the authentication circuitry 208 has determined the location of the guardian user device and the location of the primary user device, the authentication circuitry 208 may determine whether the devices are located within sufficient proximity of one another. For example, the authentication circuitry 208 may determine the distance between the guardian user device and the primary user device based on the locations of the respective user devices. The authentication circuitry 208 may use any mathematical and/or logical operations to determine the distance. For example, the authentication circuitry 208 may use Haversine's formula to determine the distance based on the location of the user devices as GPS coordinates. The authentication circuitry 208 may then determine whether the distance satisfies a proximity threshold. For example, the proximity threshold may be 20 feet. Thus, the authentication circuitry 208 may determine that the proximity threshold is satisfied if the distance between the primary user device and guardian user device is less than or equal to 20 feet. The authentication circuitry 208 may determine that the proximity threshold fails to be satisfied if the distance between the primary user device and guardian user device is greater than 20 feet.

If the location of the guardian user device is outside the proximity threshold, the process may proceed to operation 406. If the selected guardian user device is outside the proximity threshold, the configuration circuitry 210 may select another eligible guardian user device as described in operation 406. Operations 406 and 408 may be repeated until an eligible guardian user device is selected and determined to be within the proximity threshold of the primary user device. If there are no eligible guardian user devices that are within the proximity threshold, the process may proceed to operation 414.

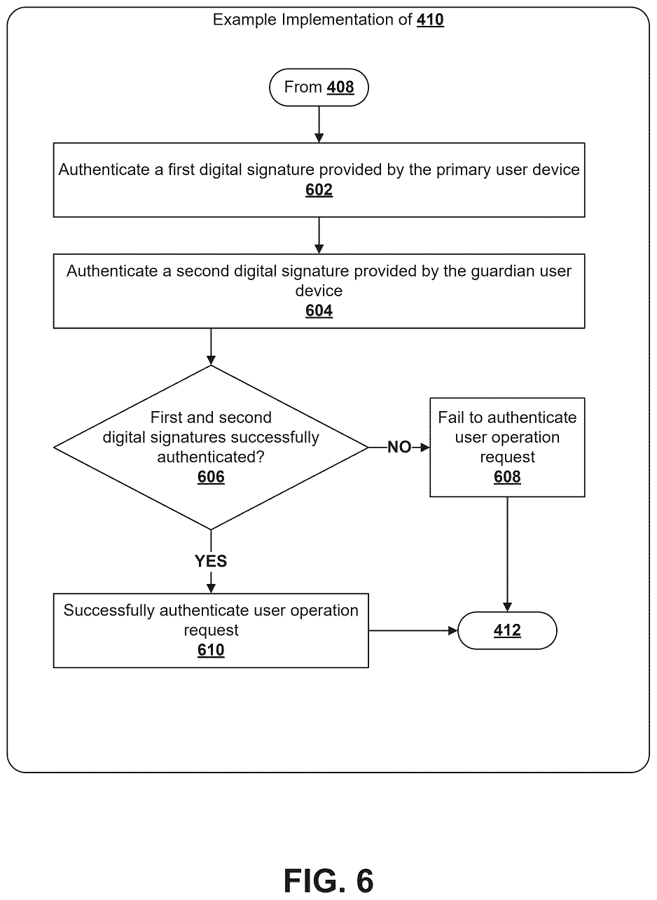

If the location of the guardian user device is within a proximity threshold from the location, the process may proceed to operation 410. Returning now to FIG. 4, as shown by operation 410, the apparatus 200 includes means, such as the memory 204, the authentication circuitry 208, or the like, for performing the dual passkey authentication routine. The authentication circuitry 208 may perform the dual passkey authentication routine to authenticate the user operation request. In particular, the dual passkey authentication routine may require that both a primary user device and the selected guardian user device are successfully authenticated using corresponding passkeys. As described in more detail in FIGS. 6-8, authentication using passkeys may require the authentication circuitry 208 to authenticate a digital signature received from the primary user device and authenticate a digital signature received from the guardian user device.

In some embodiments, operation 410 may be performed in accordance with the operations described by FIGS. 6-8. Turning first to FIG. 6, example operations are shown for performing a dual passkey authentication routine.

As shown by operation 602, the apparatus 200 includes means, such as the authentication circuitry 208 or the like, for authenticating a first digital signature provided by the primary user device. In various embodiments, the authentication circuitry 208 may authenticate a signed first challenge produced by the primary user device. As described in further detail in FIG. 7, the authentication circuitry 208 may generate a first challenge and use the communications hardware 206 to provide the first challenge to the primary user device. The primary user device may use a private cryptographic key that corresponds to the passkey established with the apparatus 200 and/or the entity associated with the apparatus 200 to sign the first challenge and produce a first digital signature. The communications hardware 206 may then receive a first challenge response that includes the first digital signature. The authentication circuitry 208 may then authenticate the first digital signature using the public cryptographic key of the passkey associated with the primary user device. The authentication circuitry 208 may perform a cryptographic verification to determine whether the first digital signature generated by the primary user device correctly corresponds to the generated first challenge. If the first digital signature corresponds to the generated first challenge, the authentication circuitry 208 may determine the first digital signature is successfully authenticated. If the first digital signature fails to correspond to the generated first challenge, the authentication circuitry 208 may determine the first digital signature has failed authentication.

In some embodiments, operation 602 may be performed in accordance with the operations described by FIG. 7. Turning now to FIG. 7, example operations are shown for authenticating a first digital signature provided by a primary user device during the dual passkey authentication routine.

As shown by operation 702, the apparatus 200 includes means, such as the authentication circuitry 208 or the like, for generating a first challenge. In some embodiments, the authentication circuitry 208 may be configured to generate a random first challenge to authenticate the primary user device 106. The first challenge may be a randomly generated piece of data, such as a number or a string. In some embodiments, the first challenge is a nonce to ensure the subsequent authentication attempt is unique and cannot be reused or replayed by attackers. The authentication circuitry 208 may generate the first challenge using any algorithm, such as a random or pseudo-random number generator (e.g., a 128-bit or 256-bit number generator). In some embodiments, the authentication circuitry 208 may store the first challenge in the memory 204.

As shown by operation 704, the apparatus 200 includes means, such as the communications hardware 206, the authentication circuitry 208, or the like, for providing the first challenge to the primary user device. Once the authentication circuitry 208 has generated the first challenge, it may cause the communications hardware 206 to provide the first challenge to the primary user device 106. The communications hardware 206 may request the primary user device 106 provide a first challenge response.

In some embodiments, the first challenge may further include instructions to cause the primary user device to prompt the primary user to authorize the primary user device to digitally sign the first challenge. In some embodiments, the instructions may further include details relating to the user operation request such that the primary user may make an informed decision regarding authorization and/or ensure the details of the user operation request are correct. Thus, the primary user may make an informed decision regarding whether to authorize or deny the request. If the primary user denies the request, the first challenge response may not include a digital signature such that the first digital signature fails to be authenticated.

As shown by operation 706, the apparatus 200 includes means, such as the communications hardware 206, the authentication circuitry 208, or the like, for receiving a first challenge response from the primary user device. In various embodiments, the primary user device 106 may sign the first challenge using the private cryptographic key of the passkey to produce a first digital signature. The communications hardware 206 may receive the first challenge response that includes the first digital signature from the primary user device 106.

As shown by operation 708, the apparatus 200 includes means, such as the authentication circuitry 208 or the like, for authenticating the first digital signature provided in the first challenge response. The authentication circuitry 208 may receive the first digital signature from the communications hardware 206. In some embodiments, the authentication circuitry 208 uses the public cryptographic key of the passkey associated with the primary user device 106 to authenticate the first digital signature.

In some embodiments, the authentication circuitry 208 may successfully authenticate the signed first challenge if the first digital signature corresponds to the public cryptographic key of the passkey for the primary user device 106 stored in the memory 204. The authentication of the signed first challenge may allow for the user operation request to continue through to the next stage in the dual passkey authentication process. In some embodiments, if the signed first challenge does not correspond to the public key, the authentication circuitry 208 may reject the first digital signature and the user operation request may not be authenticated. The authentication circuitry 208 may perform a cryptographic verification to determine whether the first digital signature correctly corresponds to the original first challenge. In some embodiments, the authentication circuitry 208 may access the original first challenge from the memory 204. If the first digital signature corresponds to the original first challenge, the authentication circuitry 208 may determine the first digital signature is successfully authenticated. If the first digital signature fails to correspond to the original first challenge, the authentication circuitry 208 may determine the first digital signature has failed authentication.

In some embodiments, the authentication circuitry 208 may determine the first challenge response was received within a threshold time window. If no first challenge response is received within the threshold time window, the authentication circuitry 208 may determine the first digital signature has failed authentication.

Returning now to FIG. 6, as shown by operation 604, the apparatus 200 includes means, such as the authentication circuitry 208 or the like, for authenticating a second digital signature provided by the guardian user device. In various embodiments, the authentication circuitry 208 may authenticate a signed second challenge produced by the selected guardian user device. As described in further detail in FIG. 8, the authentication circuitry 208 may generate a second challenge and use the communications hardware 206 to provide the second challenge to the guardian user device. The guardian user device may use a private cryptographic key that corresponds to the passkey established with the apparatus 200 and/or the entity associated with the apparatus 200 to sign the second challenge and produce a second digital signature. The communications hardware 206 may then receive a second challenge response that includes the second digital signature. The authentication circuitry 208 may then authenticate the second digital signature using the public cryptographic key of the passkey associated with the guardian user device. The authentication circuitry 208 may perform a cryptographic verification to determine whether the second digital signature generated by the guardian user device correctly corresponds to the generated second challenge. If the second digital signature corresponds to the generated second challenge, the authentication circuitry 208 may determine the second digital signature is successfully authenticated. If the second digital signature fails to correspond to the generated second challenge, the authentication circuitry 208 may determine the second digital signature has failed authentication.

In some embodiments, operation 604 may be performed in accordance with the operations described by FIG. 8. Turning now to FIG. 8, example operations are shown for authenticating a second digital signature provided by a guardian user device during the dual passkey authentication routine.

As shown by operation 802, the apparatus 200 includes means, such as the authentication circuitry 208 or the like, for generating a second challenge. In some embodiments, the authentication circuitry 208 may be configured to generate a random second challenge to authenticate the guardian user device. The second challenge may be a randomly generated piece of data, such as a number or a string. In some embodiments, the second challenge is a nonce to ensure the subsequent authentication attempt is unique and cannot be reused or replayed by attackers. The authentication circuitry 208 may generate the second challenge using any algorithm, such as a random or pseudo-random number generator (e.g., a 128-bit or 256-bit number generator). In some embodiments, the authentication circuitry 208 may store the second challenge in the memory 204.

As shown by operation 804, the apparatus 200 includes means, such as the communications hardware 206, the authentication circuitry 208, or the like, for providing the second challenge to the guardian user device. Once the authentication circuitry 208 has generated the second challenge, it may cause the communications hardware 206 to provide the second challenge to the guardian user device. The communications hardware 206 may request the guardian user device to provide a second challenge response. In some embodiments, the second challenge may also include the unique identifier that corresponds to the primary user account. Thus, the guardian user device may be configured to select the appropriate private cryptographic key to sign the challenge.

In some embodiments, the second challenge may further include instructions to cause the guardian user device to prompt the user (e.g., the primary user or guardian user) to authorize the guardian user device to digitally sign the second challenge. In some embodiments, the instructions may further include details relating to the user operation request such that the user may make an informed decision regarding authorization. For example, the instructions included in the second challenge may cause the guardian user device to prompt the user to select an “authorize” or “deny” element for a user operation request for primary user “Mark M.” for a fund transfer amount of $550. In some embodiments, the prompt may further indicate the location of the primary user device. Thus, the user of the guardian user device may make an informed decision regarding whether to authorize or deny the request. If the user denies the request, the second challenge response may not include a second digital signature such that the second digital signature fails to be authenticated.

As shown by operation 806, the apparatus 200 includes means, such as the communications hardware 206, the authentication circuitry 208, or the like, for receiving a second challenge response from the guardian user device. In various embodiments, the guardian user device may sign the second challenge using the private cryptographic key of the passkey to produce a second digital signature. The communications hardware 206 may receive the second challenge response, which may include the second digital signature from the guardian user device. The second digital signature may only be produced in an instance the user of guardian user device authorized the guardian user device to digitally sign the challenge. Otherwise, the second challenge response may not include the second digital signature.

As shown by operation 808, the apparatus 200 includes means, such as the authentication circuitry 208 or the like, for authenticating the second digital signature provided in the second challenge response. The authentication circuitry 208 may receive the second digital signature from the communications hardware 206. In some embodiments, the authentication circuitry 208 uses the public cryptographic key of the passkey associated with the guardian user device to authenticate the second digital signature. If the second challenge response does not include the second digital signature (e.g., the user of the guardian user device has denied authorization to digitally sign the challenge), the authentication circuitry 208 may automatically determine the second digital signature has failed authentication.

In some embodiments, the authentication circuitry 208 may successfully authenticate the signed second challenge if the second digital signature corresponds to the public cryptographic key of the passkey for the guardian user device stored in the memory 204. The authentication of the signed second challenge may allow for the user operation request to continue through to the next stage in the dual passkey authentication process. In some embodiments, if the signed second challenge does not correspond to the public key, the authentication circuitry 208 may reject the second digital signature and the user operation request may not be authenticated. The authentication circuitry 208 may perform a cryptographic verification to determine whether the second digital signature correctly corresponds to the original second challenge. In some embodiments, the authentication circuitry 208 may access the original second challenge from the memory 204. If the second digital signature corresponds to the original second challenge, the authentication circuitry 208 may determine the second digital signature is successfully authenticated. If the second digital signature fails to correspond to the original second challenge, the authentication circuitry 208 may determine the second digital signature has failed authentication.

In some embodiments, the authentication circuitry 208 may determine the second challenge response was received within a threshold time window. If no second challenge response is received within the threshold time window, the authentication circuitry 208 may determine no second digital signature was received, and thus, the second digital signature has failed authentication.

It will be appreciated that operations 602 and 604 and the corresponding operations described in FIGS. 7-8 may be performed simultaneously. For example, the first challenge and second challenge may be simultaneously generated and provided to the primary user device and guardian user device, respectively. In some embodiments, this may be accomplished by leveraging parallel processing techniques. Advantageously, this allows for time-sensitive user operation requests to be expedited.

Returning now to FIG. 6, as shown by operation 606, the apparatus 200 includes means, such as the authentication circuitry 208 or the like, for determining whether the first digital signature and second digital signature have been successfully authenticated.

If either the first digital signature or the second digital signature failed to be authenticated, the process may proceed to operation 608. As shown by operation 608, the apparatus 200 includes means, such as the authentication circuitry 208 or the like, for failing to authenticate the user operation request.

If the first digital signature and the second digital signature were successfully authenticated, the process may proceed to operation 610. As shown by operation 610, the apparatus 200 includes means, such as the authentication circuitry 208 or the like, for determining to successfully authenticate the user operation request.

Returning now to FIG. 4, as shown by operation 412, the apparatus 200 includes means, such as the authentication circuitry 208 or the like, for determining whether authentication of the user operation request was successful. As described above, the authentication circuitry 208 performs the dual passkey authentication routine to determine whether a first digital signature received from the primary user device is successfully authenticated and whether a second digital signature received from the guardian user device is successfully authenticated. If both the first digital signature and second digital signature are successfully authenticated, the authentication circuitry 208 determines the user operation request is successfully authenticated. If either the first digital signature, the second digital signature, or both digital signatures fail to be authenticated, the authentication circuitry 208 determines the user operation request fails.

If the user operation request fails to be authenticated, the process may proceed to operation 414. As shown by operation 414, the apparatus 200 includes means, such as the communications hardware 206, the authentication circuitry 208, or the like, for rejecting the user operation request. If the authentication circuitry 208 fails to authenticate the user operation request, this may be indicative that the primary user device identity is unable to be verified, the guardian user device identity is unable to be verified, the primary user identity is unable to be verified, and/or the guardian user identity is unable to be verified. Thus, the authentication circuitry 208 may reject the user operation request. In some embodiments, the authentication circuitry 208 may further cause the communications hardware 206 to provide a rejection notification to the primary user device and/or guardian user device.

The rejection notification may include feedback on why the user operation request was rejected. For example, the rejection notification request may indicate that the passkey provided by the primary user device or guardian user device could not be authenticated or an authentication passkey requirement was not satisfied. Thus, the rejection notification may provide the user with a reason for the user operation request rejection. Alternatively, the rejection notification may indicate that the primary user device and guardian user device are not sufficiently proximate to one another, no guardian user device was available, and/or the like.

If the user operation request is successfully authenticated, the process may proceed to operation 416. As shown by operation 416, the apparatus 200 includes means, such as the memory 204, the communications hardware 206, the operation management circuitry 212, or the like, for performing an operational routine. If the authentication circuitry 208 successfully authenticates the user operation request, the authentication circuitry 208 may prompt or authorize the operation management circuitry 212 to perform an operation routine associated with the user operation request. As described above, the user operation request may correspond to a particular category of predefined user request types. Each operation request type may be associated with an operational routine. The operational routine may include a set of instructions to be performed by the operation management circuitry 212 to fulfill the user operation request.

In some embodiments, the operational routine for each operation request type is stored in an associated memory, such as the memory 204. The operation management circuitry 212 may access the operational routine for the operation request type from the memory 204. The operation management circuitry 212 may then perform the operations and/or execute the instructions for the operational routine to fulfill the user operation request. In some embodiments, the operation management circuitry 212 may perform the operational routine based on the user-supplied data provided in the user operation request.

By way of particular example, an operation request type may be a user account logon request, and the user-supplied data may be a user credential. The operational routine may instruct the operation management circuitry 212 to cause the communications hardware 206 to establish a secure session with the requesting primary user device. Thus, the operation management circuitry 212 may cause the communications hardware 206 to establish a secure session with the primary user device. This may be performed in a substantially similar manner as described in operation 310 of FIG. 3.

As another example, an operation request type may be a fund transfer request, and the user-supplied data may include a provisioning account, a recipient account, a fund amount, and a memo line. The operational routine may instruct the operation management circuitry 212 to transfer funds of a specified fund amount from the provisioning account to the recipient account. Further, the operational routine may instruct the operation management circuitry 212 to provide the text in the memo line to the recipient account. Thus, the operation management circuitry 212 may cause funds in the amount specified in the user operation request to transfer from the provisioning account to the recipient account along with providing text in the memo line.

As another example, an operation request type may be a primary user account update request, and the user-supplied data may include user input values for a particular user account data field (e.g., legal name, residential address, work address, phone number, trusted user devices, trusted locations, or the like). The operational routine may instruct the operation management circuitry 212 to update the primary user account to reflect the user input values for the corresponding data fields. Thus, the operation management circuitry 212 may cause the primary user account to be updated to reflect the user input values provided in the user operation request.

As yet another example, an operation request type may be a new account opening request, and the user-supplied data may include various demographic information, a social security number, a phone number, an email address, etc. The operational routine may instruct the operation management circuitry 212 to generate a new account corresponding to the request account type for the primary user account and update the data fields in the user account with the provided user-supplied data. Thus, the operation management circuitry 212 may generate a new account for the primary user and automatically input the user-supplied data values in the corresponding data fields for the new account. In some embodiments, the operational routine may further instruct the operation management circuitry 212 to link the new user account and the current primary user account such that user operation requests pertaining to the new user account may be authenticated using the passkey currently associated with the primary user account, the primary user device, and/or the authentication passkey requirement set for the passkey.

The operation management circuitry 212 may further cause the communications hardware 206 to provide a request status message to the primary user device. The request status message may indicate the current status of the user operation request such that the user may be informed of the real-time status for completion of the user operation request. The request status message may further inform the primary user of whether the user operation request has been completed. In some embodiments, the request status message may serve as a receipt of the completion of the user operation request.

FIGS. 3-8 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special-purpose, hardware-based computing devices that perform the specified functions or by combinations of special-purpose hardware and software instructions.

In some embodiments, some of the operations described above in connection with FIGS. 3-8 may be modified or further amplified. Furthermore, in some embodiments, additional optional operations may be included. Modifications, amplifications, or additions to the operations above may be performed in any order and in any combination.

### Conclusion

As described above, example embodiments provide methods and apparatuses that enable use of a dual passkey authentication routine for enhanced user account security. Example embodiments thus provide tools that overcome the problems faced by tradition passkey systems, which rely on a single user device, leaving a potential vulnerability if that device is compromised. In contrast, the use of a dual passkey authentication routine contemplates the use of second user device (e.g., a guardian user device) used during authentication of a user operation request, thus addressing the various shortcomings associated with conventional passkey systems. In particular, example embodiments allow a guardian user device to be configured with a passkey that is linked or associated with the primary user account. Thus, the guardian user device may be used to digitally sign a challenge during a dual passkey authentication routine but does not have access into the primary user account. The use of a second passkey reduces reliance on any one user device or key for user operation request authorization and thus enhances resilience against user device loss or compromise.

As these examples all illustrate, example embodiments contemplated herein provide technical solutions that solve real-world problems faced during passkey authentication. Recent progress in cryptanalysis in a post-quantum computing environment has made passkey authentication a potential target. At the same time, the rising ubiquity of user devices that may provide additional user data on a device has unlocked new avenues for improving the security of passkey authentication, and example embodiments described herein thus represent a technical solution to these real-world problems.

Many modifications and other embodiments of the inventions set forth herein will come to mind to one skilled in the art to which these inventions pertain, having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for improved authentication, the method comprising:
receiving, by communications hardware, a user operation request from a primary user device associated with a primary user, wherein the user operation request pertains to a primary user account of the primary user and corresponds to an operation request type;
determining, by authentication circuitry and based on the primary user account, a dual passkey authentication requirement for the operation request type;
selecting, by configuration circuitry and based on the dual passkey authentication requirement, a guardian user device;
performing, by the authentication circuitry, a dual passkey authentication routine to determine whether to authenticate the user operation request, wherein the dual passkey authentication routine comprises:
authenticating, by the authentication circuitry, a first digital signature provided by the primary user device using a public cryptographic key of a passkey for the primary user device, and
authenticating, by the authentication circuitry, a second digital signature provided by the guardian user device using a public cryptographic key of a passkey for the guardian user device, wherein the user operation request is successfully authenticated in an instance in which the first digital signature and second digital signature are successfully authenticated; and
in response to successfully authenticating the user operation request, performing, by operation management circuitry and based on the user operation request, an operational routine associated with the operation request type for the primary user account.

2. The method of claim 1, further comprising:
generating, by the authentication circuitry, a first challenge for the primary user device;
providing, by the communications hardware, the first challenge to the primary user device; and
in response to providing the first challenge, receiving, by the communications hardware, a first challenge response comprising the first digital signature from the primary user device.

3. The method of claim 1, further comprising:
generating, by the authentication circuitry, a second challenge for the guardian user device;
providing, by the communications hardware, the second challenge to the guardian user device; and
in response to providing the second challenge, receiving, by the communications hardware, a second challenge response comprising the second digital signature from the guardian user device.

4. The method of claim 1, further comprising:
determining, by the authentication circuitry, a location of the primary user device from current user device data associated with the primary user device;
determining, by the authentication circuitry, a location of the guardian user device from current user device data associated with the guardian user device; and
determining, by the authentication circuitry, whether the location of the guardian user device is within a proximity threshold from the location of the primary user device, wherein the dual passkey authentication routine is performed in response to determining that the location of the guardian user device is within the proximity threshold from the location of the primary user device.

5. The method of claim 1, wherein the primary user device and the guardian user device are both associated with the primary user.

6. The method of claim 1, wherein the guardian user device is associated with a guardian user that is different than the primary user.

7. The method of claim 1, further comprising identifying, by the configuration circuitry, an availability schedule for candidate guardian user devices associated with the primary user account, wherein the guardian user device is selected based on a current time and an associated availability schedule.

8. The method of claim 1, further comprising:
during a secure session with the primary user device, receiving, by the communications hardware, a dual passkey configuration request from the primary user device; and
updating, by the configuration circuitry, the primary user account to include the dual passkey authentication requirement for the operation request type.

9. The method of claim 8, further comprising:
providing, by the communications hardware, a configuration request to the guardian user device, wherein the configuration request authorizes the guardian user device to generate the passkey for the guardian user device and requests the guardian user device to provide the public cryptographic key of the passkey;
receiving, by the communications hardware, a configuration response from the guardian user device, wherein the configuration response comprises the public cryptographic key of the passkey for the guardian user device; and
storing, by the authentication circuitry, the public cryptographic key for the guardian user device in association with the primary user account.

10. An apparatus for improved authentication, the apparatus comprising:
communications hardware configured to receive a user operation request from a primary user device associated with a primary user, wherein the user operation request pertains to a primary user account of the primary user and corresponds to an operation request type;
authentication circuitry configured to determine, based on the primary user account, a dual passkey authentication requirement for the operation request type;
configuration circuitry configured to select, based on the dual passkey authentication requirement, a guardian user device,
wherein the authentication circuitry is further configured to perform a dual passkey authentication routine to determine whether to authenticate the user operation request, wherein the authentication circuitry is configured to perform the dual passkey authentication routine by:
authenticating a first digital signature provided by the primary user device using a public cryptographic key of a passkey for the primary user device, and
authenticating a second digital signature provided by the guardian user device using a public cryptographic key of a passkey for the guardian user device, wherein the user operation request is successfully authenticated in an instance in which the first digital signature and second digital signature are successfully authenticated; and
wherein the apparatus further comprises operation management circuitry configured to, in response to successfully authenticating the user operation request, perform, based on the user operation request, an operational routine associated with the operation request type for the primary user account.

11. The apparatus of claim 10, wherein the authentication circuitry is further configured to generate a first challenge for the primary user device,
wherein the communications hardware is further configured to:
provide the first challenge to the primary user device; and
in response to providing the first challenge, receive a first challenge response comprising the first digital signature from the primary user device.

12. The apparatus of claim 10, wherein the authentication circuitry is further configured to generate a second challenge for the guardian user device,
wherein the communications hardware is further configured to:
provide the second challenge to the guardian user device; and
in response to providing the second challenge, receive a second challenge response comprising the second digital signature from the guardian user device.

13. The apparatus of claim 10, wherein the authentication circuitry is further configured to:
determine a location of the primary user device from current user device data associated with the primary user device;
determine a location of the guardian user device from current user device data associated with the guardian user device; and
determine whether the location of the guardian user device is within a proximity threshold from the location of the primary user device, wherein the dual passkey authentication routine is performed in response to determining that the location of the guardian user device is within the proximity threshold from the location of the primary user device.

14. The apparatus of claim 10, wherein the primary user device and the guardian user device are both associated with the primary user.

15. The apparatus of claim 10, wherein the guardian user device is associated with a guardian user that is different than the primary user.

16. The apparatus of claim 10, wherein the configuration circuitry is further configured to identify an availability schedule for candidate guardian user devices associated with the primary user account, wherein the guardian user device is selected based on a current time and an associated availability schedule.

17. The apparatus of claim 10, wherein the communications hardware is further configured to receive, during a secure session with the primary user device a dual passkey configuration request from the primary user device,
wherein the configuration circuitry is further configured to update the primary user account to include the dual passkey authentication requirement for the operation request type.

18. The apparatus of claim 17, wherein the communications hardware is further configured to:
provide a configuration request to the guardian user device, wherein the configuration request authorizes the guardian user device to generate the passkey for the guardian user device and requests the guardian user device to provide the public cryptographic key of the passkey; and
receive a configuration response from the guardian user device, wherein the configuration response comprises the public cryptographic key of the passkey for the guardian user device,
wherein the authentication circuitry is further configured to store the public cryptographic key for the guardian user device in association with the primary user account.

19. A computer program product for improved authentication, the computer program product comprising at least one non-transitory computer-readable storage medium storing software instructions that, when executed, cause an apparatus to:
receive a user operation request from a primary user device associated with a primary user, wherein the user operation request pertains to a primary user account of the primary user and corresponds to an operation request type;
determine, based on the primary user account, a dual passkey authentication requirement for the operation request type;
select, based on the dual passkey authentication requirement, a guardian user device;
perform a dual passkey authentication routine to determine whether to authenticate the user operation request, wherein the dual passkey authentication routine comprises:
authenticating a first digital signature provided by the primary user device using a public cryptographic key of a passkey for the primary user device, and
authenticating a second digital signature provided by the guardian user device using a public cryptographic key of a passkey for the guardian user device, wherein the user operation request is successfully authenticated in an instance in which the first digital signature and second digital signature are successfully authenticated; and; and
in response to successfully authenticating the user operation request, perform, based on the user operation request, an operational routine associated with the operation request type for the primary user account.

20. The computer program product of claim 19, wherein the software instructions, when executed, further cause the apparatus to:
provide a configuration request to the guardian user device, wherein the configuration request authorizes the guardian user device to generate the passkey for the guardian user device and requests the guardian user device to provide the public cryptographic key of the passkey;
receive a configuration response from the guardian user device, wherein the configuration response comprises the public cryptographic key of the passkey for the guardian user device; and
store the public cryptographic key for the guardian user device in association with the primary user account.
